(19) United States
(12) Patent Application Publication
(10) Pub. No.: US 2014/0289084 A1
(43) Pub. Date: Sep. 25, 2014

(54) SWEAT EQUITY FUND MANAGEMENT SYSTEM

(71) Applicant: James Richard TERRELL, II, Charlotte, NC (US)

(72) Inventor: James Richard TERRELL, II, Charlotte, NC (US)

(21) Appl. No.: 14/214,860

(22) Filed: Mar. 15, 2014

Related U.S. Application Data
(60) Provisional application No. 61/799,701, filed on Mar. 15, 2013.

(51) Int. Cl. G06Q 40/00

(52) U.S. Cl. CPC G06Q 40/00
USPC 705/35

(57) ABSTRACT

A system allows discovery of potential sweat equity investment partners and groups them into investment funds. The system allows for the valuation, application and tracking of fund sweat equity to funded projects. A corresponding method includes tracking fund membership of a group of sweat equity investors called daemons, tracking sweat equity invested into the fund by the daemons, computing and tracking the fund ownership of individual daemons based on the amount of their investments, reinvesting the fund's pool of sweat equity into external ventures, in exchange for cash and/or ownership consideration in the funded venture, computing and tracking the valuation of funded ventures, computing and tracking the fund ownership stakes in funded ventures, tracking the proceeds of liquidation of ownership stakes in funded ventures, and distributing venture liquidation proceeds to daemons based on their fund ownership.

### CROSS-REFERENCE TO RELATED APPLICATION

The present application is a U.S. nonprovisional patent application of, and claims priority under 35 U.S.C. §119(e) to, U.S. provisional patent application Ser. No. 61/799,701, filed Mar. 15, 2013, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to systems and methods for managing sweat equity funds.

2. Background

In the business community, early-stage or “startup” companies are not always able to attract the funding or investment needed to develop and prove out a particular business model. In some cases, founders may “bootstrap” their companies by investing their personal funds to hire the needed development resources. In other cases, a founder may personally have some or all of the necessary development skills, so the founders may perform some or all of the work, investing their time and effort as “sweat equity.”

In cases where the founders do not have all of the required skills, or the personal funds necessary to procure them, they may turn to early-stage or “seed” investment funds, made up of a group of “Angel Investors” who pool their funds and invest in multiple ventures, sharing risk and reward. In return for an ownership stake in the startup, the founders receive cash that they can use to hire the resources needed to build their product.

If seed funding is unattractive, or not available, founders may choose to seek part-time “moonlighters” with the required development skills and offer them an ownership stake in return for their sweat equity “investment” in their startup. These sweat equity investors are known as the “Daemons” in this disclosure. Angels invest cash, Daemons invest sweat.

Although Daemons contribute effort instead of money, their time is still valuable. In some cases where they are working for only the “promise” of financial return, they may have other employment and are contributing their “sweat equity” after-hours. Thus, Daemons have to be as selective with their time and talent investment as angel investors are with their money. Daemons know that most startups eventually fail to meet initial expectations, and will not lightly invest all of their effort in a venture that has such tenuous prospects, as is the case with almost all startups.

The diversified investment model used by Angel Funds offers a solution to the potential Daemon investor. By pooling their sweat investments with multiple Daemon investment partners, and pursuing multiple investment ventures, the Daemons can share their investment risks and rewards in the same way as the Angel Fund. This approach is called the Daemon Fund.

While the Daemon Fund concept does offers the benefits of investment diversification, it comes with its own unique set of challenges. The first challenge is that the “quality” or value of a financial investment is generally the same for all investors since cash is the typical investment instrument, and cash is quite fungible. Investor A's money has the same value as the money invested by Investor B. The same cannot be said of sweat equity. With sweat equity, the productivity and quality of the effort (or “investment”) put in by individual Daemons may vary greatly, and need to be adjusted and accounted for. For example, some Daemons may possess skill sets with higher market values than others, and experience and proficiency may also differ significantly.

Additionally, many or all of the Daemons may be moonlighters, and may have existing IP Assignment, Non-compete, or other agreements with current or previous employers which restrict the types of moonlighting activities they can pursue. In light of these existing agreements, care must be taken to avoid entanglement with existing 3^{rd}-party agreements and ultimately ensure that all effort invested by Daemons belongs to them and can be legally transferred to the startups that the Daemon Fund invests in.

In light of these challenges and opportunities, this disclosure describes a Daemon Fund Management System that makes possible the creation and management of “Daemon Funds”, which invest sweat equity as a group rather than individually, thus reducing risk and increasing the likelihood for a positive return on their investment.

### SUMMARY OF THE PRESENT INVENTION

Broadly defined, the present invention according to one aspect is a computer-implemented method of organizing and managing a diversified sweat equity investment fund, including: establishing a database, in at least one electronic data store, to track fund membership of a group of sweat equity investors, each investor defining a daemon; tracking, in the at least one electronic data store, sweat equity invested into a fund by the daemons; computing, via a computer device, and tracking, in the at least one electronic data store, the fund ownership of individual daemons based on the amount of their investments; reinvesting the fund's pool of sweat equity into at least one external ventures in exchange for cash and/or ownership consideration in the at least one funded venture; computing, via a computer device, and tracking, in the at least one electronic data store, the valuation of funded ventures; computing, via a computer device, and tracking, in the at least one electronic data store, the fund ownership stakes in funded ventures; tracking the proceeds of liquidation of ownership stakes in funded ventures; and distributing venture liquidation proceeds to the daemons based on the respective fund ownership of each daemon.

In a feature of this aspect, oversight of the fund is assigned to one or more fund managers who have final say in all fund actions, over and above general fund membership or committees.

In another feature of this aspect, daemon membership in the fund is subject to review, and the method further includes: organizing a membership committee of fund members and/or external advisors to recommend changes in membership status, including but not limited to acceptance into the fund, or expulsion from the fund; and implementing a system whereby the fund accepts or rejects membership committee recommendations.

In another feature of this aspect, the value of the sweat equity investments made by daemons into the fund are subject to an investment multiplier which sets the value of their fund investments relative to other fund members, and the method further includes: upon fund admittance assigning a numerical multiplier to each daemon, based on their previous experience, skills, or other recognized values; establishing a review process to periodically update investment multipliers; and adjusting the fund investment value of sweat equity investments by each daemon's investment multiplier.

In another feature of this aspect, investments of pooled fund sweat equity to funded ventures is subject to review by establishing a process by which funding proposals reviewed, valued, recommended, and then finally accepted or rejected by the fund.

In another feature of this aspect, daemons are grouped into teams, and the method further includes: assigning daemons to teams; assigning teams to lead sweat equity investment for specific fund investment ventures; and assigning and tracking the sweat equity investment budget for each team and funded venture. In further features, lead teams receive an additional bonus percentage of venture liquidation proceeds from their assigned ventures prior to the general fund distribution, and the method further includes: tracking an agreed-upon team bonus percentage which is set when a team is assigned to the lead role for an investment venture, calculating team bonus proceeds and subtracting them from and prior to the general fund distribution, and distributing team bonus proceeds to lead team member daemons relative to the value of the sweat equity they invested in the venture that is being liquidated; and daemons who are not part of a venture's lead team are able participate in the team bonus cut of venture liquidation proceeds, wherein the method further includes: tracking and approving requests by teams for investment in team ventures by non-team daemons, tracking daemon sweat equity investments for each funded venture, and distributing team bonus proceeds to non-lead-team member daemons as if they were team members, relative to the value of the sweat equity they invested in the lead team's venture that is being liquidated.

In another feature of this aspect, an advisory pool of external advisors is are made available to the fund, and the method further includes: tracking and approving requests for external advisors to the advisory pool by fund entities; and tracking the value of sweat equity investments made by advisors and reporting it back to the advisory pool. In further features, the advisory pool has an ownership stake in the Daemon Fund and participates in the distribution of venture liquidation proceeds; and the advisors are treated in the same way as fund daemons for the purposes of participation in the distribution of venture liquidation proceeds.

In another feature of this aspect, sweat equity tasks are classified and assigned multipliers, and the method further includes: identifying classes of tasks and assigning multipliers based on their relative value to the fund; tagging each investment of sweat equity with a classification; and adjusting the relative valuation of each investment of sweat equity based on its classification.

In another feature of this aspect, sweat equity invested by the daemons is automatically tracked and tagged, and the method further includes: automatically recording the time durations of sweat equity activities performed by the daemons; automatically collecting tagging information, during sweat equity activities, which supports and validates their investment value to the fund; and verifiably associating or otherwise attaching the tagging information to sweat equity at the time it is submitted to the fund IP repositories. In further features, sweat equity investments, work products and verifiable tagging information are stored together in the fund IP repositories; the sweat equity tagging information is collected by a software time tracking product which installs on the daemon's computer and tracks their interaction with the system during development including their input, applications used, and names of the open windows they interact with; the fund IP repositories are electronic data stores such as a document management system or a software revision control system; and/or the IP developed by the daemon and the associated tagging information are digitally signed as one element at the time they are added to the fund IP repositories using a digital key belonging to the daemon who created the IP.

In another feature of this aspect, an audit trail is maintained that certifies that the daemons legally own the IP they create and invest into the fund, wherein the method further includes: storing active IP-related agreements that daemons have with third parties; categorizing potential areas of interference by task type and venture type; when assigning tasks, limiting daemons from working on tasks that might cause potential IP interferences; evaluating each daemon in the fund for potential interference when funding a new venture and sequestering those who might interfere from contributing IP; requiring statements by the daemons with each of their sweat equity IP investments certifying that they have not violated their existing agreements; storing certifications together with the associated IP or other sweat equity products in the fund IP repository; digitally signing, as one element, the IP and its associated certifications using a digital key identifying the daemon who created and certified the IP; and producing an IP certification report for funded ventures listing all of the IP developed by the fund for their project, the daemons who developed the IP, and their certifications of right to develop and deliver the IP.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a block diagram of a Daemon Fund Management System, in accordance with a preferred embodiment of the present invention;

FIG. 2 is a flow chart showing the Daemon Fund Life Cycle in a Daemon Fund Management System of FIG. 1;

FIG. 3 is a flow chart showing the Fund Formation phase of the Daemon Fund Life Cycle in FIG. 2;

FIG. 4 is a flow chart showing the Funding phase of the Daemon Fund Life Cycle of FIG. 2;

FIG. 5 is a flow chart showing the Investment phase of the Daemon Fund Life Cycle in FIG. 2;

FIG. 6 is a flow chart showing the Distribution and Liquidation phase of the Daemon Fund Life Cycle in FIG. 2;

FIG. 7 is a block diagram detailing the Daemon Artifacts in FIG. 1;

FIG. 8 is a flow chart showing an exemplary implementation of a Dynamic Equity Split model in one preferred embodiment of the system in FIG. 1;

FIG. 9 is a flow chart showing an exemplary implementation of the Daemon Fund Value Cycle in one preferred embodiment of the system in FIG. 1;

FIG. 10 is a flow chart showing an exemplary implementation of the Daemon Fund Sweat to Equity Model in one preferred embodiment of the system in FIG. 1; and

FIG. 11 is a flow chart showing an exemplary implementation of the Daemon Fund IP Certification model in one preferred embodiment of the system in FIG. 1.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

### Common Terms

Generally, when used herein, the following terms are have the meanings set forth below, wherein:

“Advisors” are external daemons with specialized and/or infrequently needed skill sets that assist the Daemon Fund in return for an ownership stake in the fund;

“Advisory Pool” is the entity that the Advisors belong to. Might set up as another “meta” Daemon Fund;

“Daemon” is a sweat equity fund investor;

“Daemon (Investment) Fund” is an investment fund made up of Daemons who pool their sweat equity resources and invest those resources in multiple opportunities, sharing the risk and reward from those investments;

“Equity Split” is the division of investment ownership amongst multiple investors;

“Fund manager(s)” are (optional) fund members who have oversight roles and who the final say in all fund actions, over and above fund general membership or committees. Typically these individuals would be the principals for the underlying fund corporation or other business structure;

“Investment Fund” is a group of investors who pool their resources, invest in multiple opportunities, and share the risk and reward from those investments;

“Investment” is sweat equity added to the fund by a Daemon, or the pooled sweat equity held by the fund offered to a startup in exchange for ownership consideration in the startup;

“Investment Focus” is a particular type of startup that that the fund will invest in. For example, “Consumer Web”, “Mobile Applications”, “Cloud Computing”, etc;

“Investment Multiplier” is a numeric multiplier which sets the value of Daemon sweat equity fund investments relative to other fund members. Usually related to their experience or skill levels in the areas of fund investment focus;

“Investor” is someone who invests cash, sweat equity or other value into an investment fund;

“IP Agreements” are 3^{rd}-party agreements that limit the scope of a Daemons involvement in Daemon Fund investment opportunities. Typically these are the employment, non-compete and IP assignment agreements with the Daemons current employer(s) or clients;

“IP Certification Chain” is a trail of documentation that certifies that the Daemons created IP on their own time without using their employer's resources or ideas;

“Project” or “Startup” is a venture; and

“Venture” is an investment funded by the Daemon Fund from its pool of sweat equity.

### Daemon Fund Management System and Life Cycle

Referring now to the drawings, in which like numerals represent like components throughout the several views, the preferred embodiments of the present invention are next described. The following description of the preferred embodiment(s) is merely exemplary in nature and is in no way intended to limit the invention, its application, or uses.

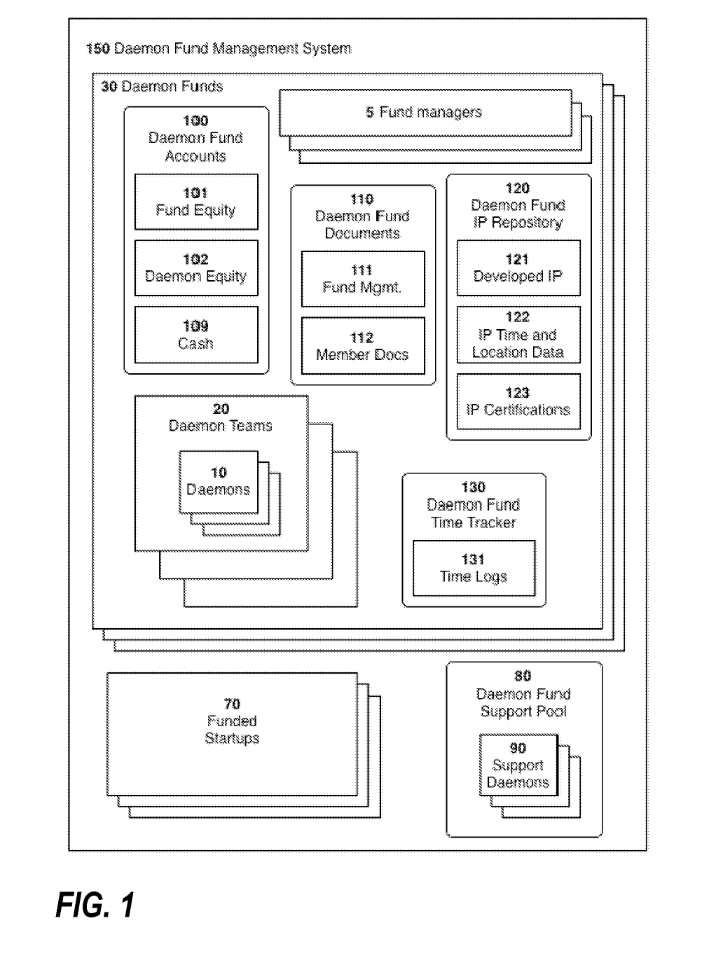

FIG. 1 is a block diagram of a Daemon Fund Management System 150 in accordance with a preferred embodiment of the present invention. As shown therein, the Daemon Fund Management System 150 may include: one or more Daemon Fund Managers 5, a Daemon Fund Support Pool 80, one or more Daemon Funds 30, and one or more Funded Startups 70.

Each Daemon Fund Support Pool 80, may include multiple Support Daemons 90. In one preferred embodiment of a Daemon Fund Management System 150, the Support Daemons 90 may include but are not limited to technical management experts, attorneys, business experts, and investment committee advisors. The Support Daemons 90 are a resource to one or more Daemon Funds 30.

A Daemon Fund 30 may include one or more Daemon teams 20 of Daemons 10, or people investing their sweat equity in a Daemon Fund 30. A Daemon Fund 30 may also include artifacts such as: Daemon Fund Accounts 100 including, Fund equity 101, Daemon Equity 102, and Cash 109; Daemon Fund Documents 110 for fund management 111 and Daemon membership documentation 112; a Daemon Fund Intellectual Property (IP) Repository 120 for developed IP 121, IP Time and Location Data 122, and IP Certifications 123; and a Daemon Fund Time Tracker tool 130 used to track each Daemon's “sweat equity” in Time Logs 131. Each of these will be described in greater detail hereinbelow.

It will be appreciated that the various methods and functions described and contemplated herein may be implemented using a variety of computer devices, including but not limited to handheld devices, desktop computers, servers, mainframes, and the like, using public (i.e., internet) and/or private networks, and making use of electronic data stores internal to the computer devices and/or external to such devices (i.e., separate databases and the like). Furthermore, in one or more embodiments, implementation may utilize various additional technologies such as cloud services, Software as a Service (SaaS), and/or the like.

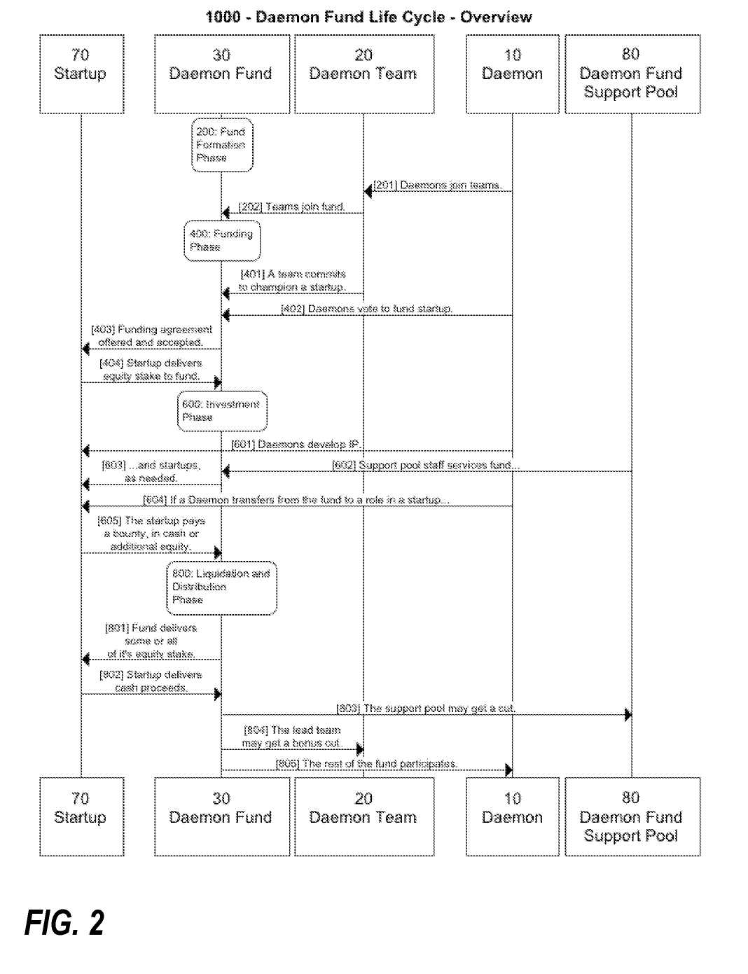

FIG. 2 is a flow chart showing the Daemon Fund Life Cycle 1000 in a Daemon Fund Management System 150. The Daemon Fund Life Cycle 1000 consists of four major phases, a Fund Formation phase 200, a Funding phase 400, an Investment phase 600, and a Liquidation and Distribution phase 800 in one preferred embodiment of the present invention. In the Fund Formation Phase 200, Daemons 10 join a team 201, and then the Daemon teams 20 join a Fund 202. Following in the Funding Phase 400, a Daemon Team 20 commits to champion a startup 401, Daemons 10 vote to fund a startup 402, a funding agreement is offered by the Daemon Fund 30 and accepted 403 by the Startup 70. Finally, the Startup 70 delivers an equity stake 404 to the Daemon Fund 30.

After the Daemon Fund is Formed 200 and Funded 400, the Investment phase 600 begins and the Daemons 10 begin developing intellectual property (IP) or other sweat equity deliverables 601 which are delivered to the startups 70. The Daemon Fund Support Pool 80 provides services 602, 603 for the Daemon Fund 30 and/or directly to the Startup 70 if or when they are required.

At any point during or following the Investment phase 600, individual Daemons might choose to leave the Daemon Fund 30 in order to take employment with one of the startups 70. At this point, the Daemon Fund 30 may require the Startup 70 to pay a bounty, in cash or additional equity, back to the Daemon Fund 30 as a recruiting bonus. The Investment phase 600 continues until the Daemon Fund 30 completes the development of IP required for the Startup 70.

At some point, the startup may undergo a “liquidity event” whereby some or all of its equity is converted to cash and distributed to the Startup's 70 investors. This typically occurs sometime after the development of IP is complete, and thus the investment phase 600 is complete, but a partial liquidation could be reasonably expected to happen at any time. During the Liquidation and Distribution phase 800, the Daemon Fund 30 delivers some or all of its equity stake 801 to the Startup 70 and, in return, the Startup delivers cash or other proceeds to the Daemon Fund 802. The Daemon Fund 30 must then distribute the cash. The support pool may get a cut 803, the Daemons 10 who worked on the Startup 70, including and especially the lead or “champion” Daemon Team members may get a bonus cut 804 up front, with the remaining proceeds distributed to the rest of the Daemons 10 in the fund 805 based on their fund participation. Each of these phases will be described in greater detail hereinbelow.

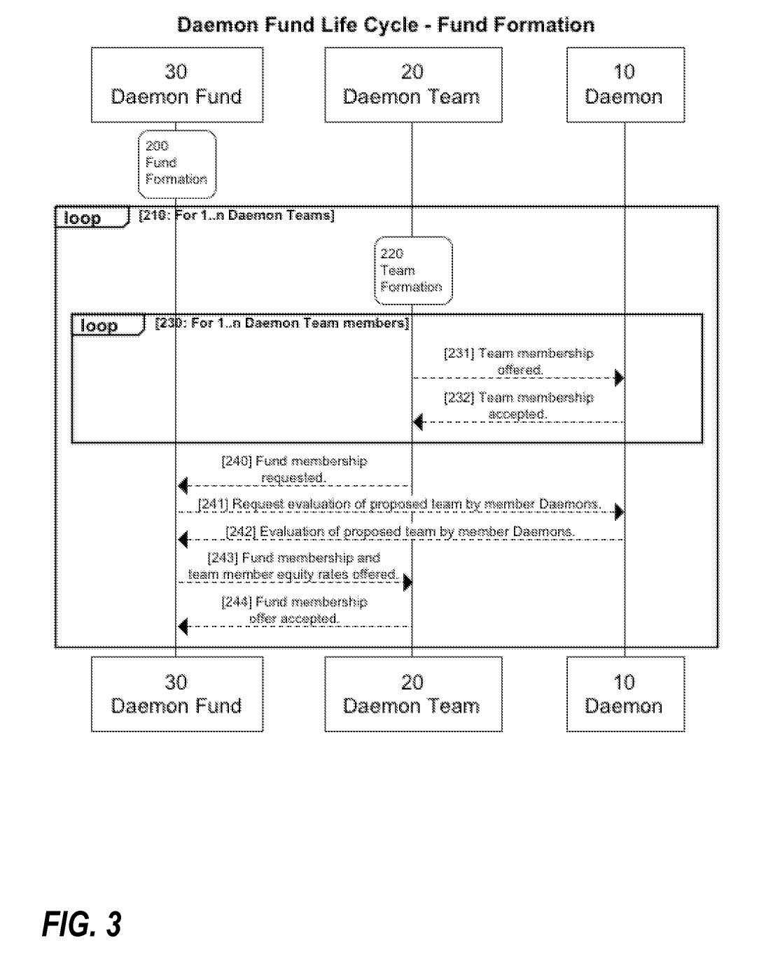

FIG. 3 is a flow chart showing the Fund Formation phase 200 of the Daemon Fund Life Cycle 1000 in detail. For each Daemon Fund 30, 1 . . . n Daemon teams 20 may be formed and each Daemon team 20 may have 1 . . . n Daemons 10 as members. In one preferred embodiment, an organization of Daemons exists, including a Daemon Fund Support Pool 80. Based on the expertise of each Support Pool Daemon, they may be made available to Daemon Funds 30 in exchange for a cut of Daemon Fund ownership. The Manager 5 of the Daemon Fund 30 recruits a group of Daemon Team Leaders for a Daemon Fund 30. The Daemon Team leaders offer Team membership 231 to Daemons 10 and when a Daemon 10 accepts team membership 232, they are placed on that Daemon Team 20. Daemon teams 20 may consist of any roles or resources, but, in this preferred embodiment, they include Daemons 10 with expertise in the areas of technology, including developers, managers and investment experts. For example, a Daemon Team 20 of technology investment experts may be formed as well as a Daemon Team 20 of programmers. Also, a Daemon Team 20 of specialists in prototyping a particular technology may be formed.

After a Daemon Team 20 is formed, the team may make a fund membership request 240. This action is followed by the Daemon Fund's request for evaluation of the proposed team by the member Daemons 241. The evaluation of the proposed team is completed by the member Daemons 242 and is given back to Daemon Fund Manager 5 and reviewed. When a Daemon Team 20 is deemed worthy of joining the Daemon Fund 30, fund membership and team member equity rates are offered 243. From 1 . . . n Daemon Team fund memberships may be offered and accepted, depending on the expertise or talent pool the Daemon Fund Manager 5 is trying to assemble, in an effort to attract Startups 70 that are interested in partnering with the Daemon Fund 30. The Funding Formation phase 400 may or may not continue simultaneously with the remaining phases in the Daemon Fund Life Cycle 1000.

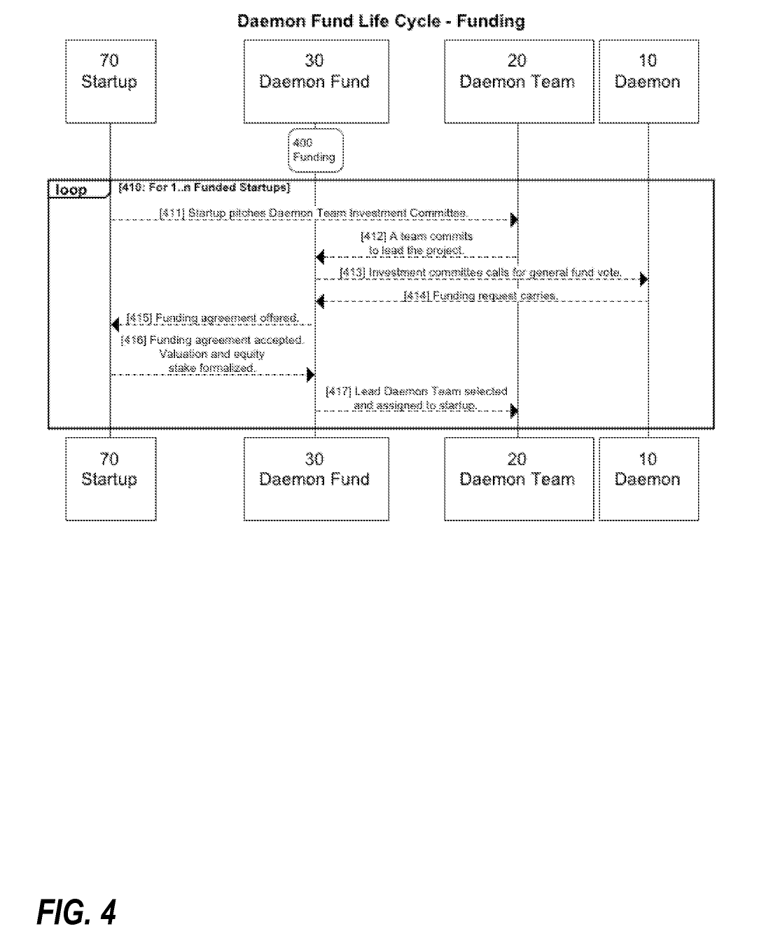

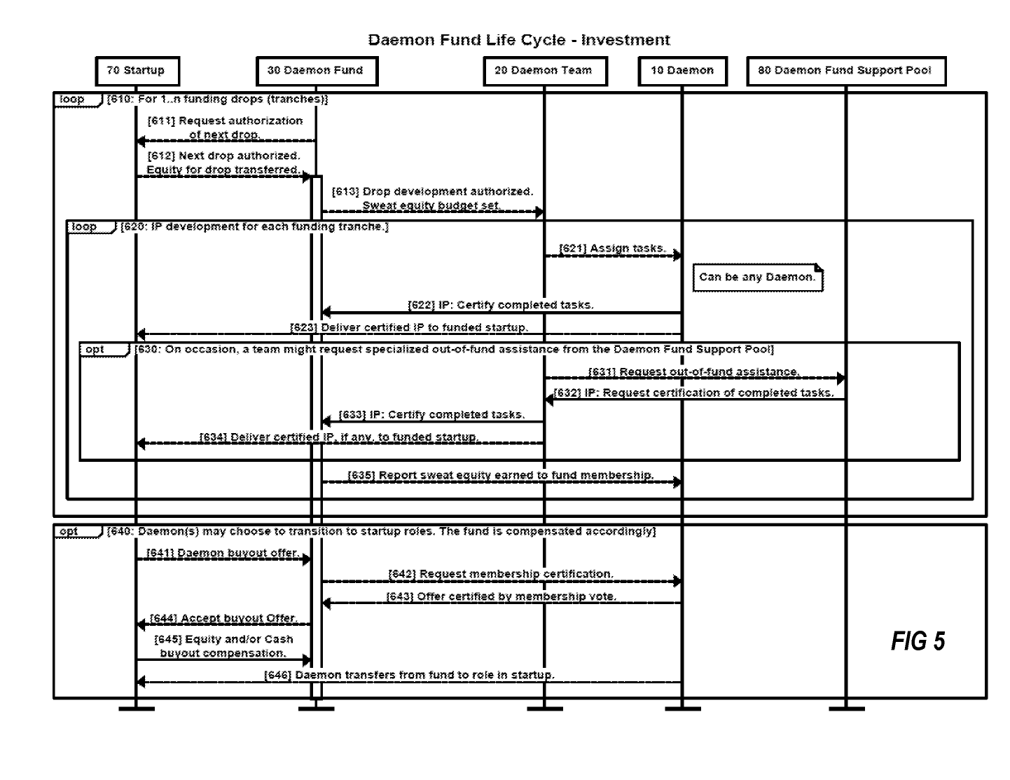

FIG. 4 is a flow chart showing the Funding phase 400 of the Daemon Fund Life Cycle 1000 in detail. Each Daemon Fund 30 may have 1 . . . n Funded Startups 410, therefore the Funding Phase 400 may repeat 1 . . . n times in the Daemon Fund Life Cycle 1000. The Funding phase 400 begins when a Startup approaches a Daemon Fund with an interest in using 1 . . . n of their Daemon Teams 20 to Fund the Startup 411. In this embodiment of the invention, the Daemon Fund 30 would organize an investment committee responsible for reviewing the viability of Startup projects drawn from the Daemon Fund Managers 5, Daemon Teams 20, and fund Daemons 10 in general. The Startup pitches the Daemon Fund investment committee 411, which selects promising opportunities and presents them to the Fund. For the Funding 400 to move forward, a Daemon Team 20 commits to lead the project 412 and the investment committee calls for a general fund vote 413. All Daemons 10 committed to a Daemon Fund 30, even if they are not on the Daemon Team 20 for a particular Startup, share in the profits of the Daemon Fund 30, therefore all Daemons 10 vote on Funding agreements. When a funding request carries 414, the Daemon Fund offers a Funding Agreement 415, and if the funding agreement is accepted, valuation and equity stakes are formalized 416. Finally, a Lead Daemon Team is selected and assigned to the Startu/p 417. This team becomes responsible for the success of the funding project, and organizes and leads all development on the project, pulling in other Daemons 10 or entire Daemon Teams 20 as needed.

FIG. 5 is a flow chart showing the Investment phase 600 of the Daemon Fund Life Cycle 1000 in detail. After a Startup 70 is Funded 400 by a Daemon Fund 30, the Daemon Fund 30 begins their Investment Phase 600. For 1 . . . n funding drops or tranches 610, the Daemon Fund 30 requests authorization of the next drop 611, or packet of work. The Startup authorizes the work and the equity for the drop is transferred to the fund 612. Next, the development is authorized by the Daemon Fund Manager 5 and a sweat equity budget is set 613 for the Daemon Team, which sets the maximum amount of sweat equity that can be put forth, or invested, for the current tranche.

For each Daemon Team 20 that is authorized to do development 613, IP development begins 620 with the assigning of tasks 621. Tasks are usually assigned to a Daemon Team member 20, but may also be assigned to any Daemon 10. As tasks are completed, the Daemons 10 certify the completed tasks 622 and they are recorded in the Daemon Fund IP Repository 120. Daemons then deliver the certified IP to the funded Startup 623.

In one embodiment, a Daemon Team 20 may request specialized out-of-fund assistance from the Daemon Fund Support Pool 630. A request for out-of fund assistance 631 occurs. As tasks or IP are completed the Daemon Support Pool 80 requests certification of completed tasks 632. The Daemons certify the completed tasks 633 and they are recorded in the Daemon Fund IP Repository 120. In the case where there is IP, which needs to be delivered to the Startup 70, the Daemon team 20 then delivers the certified IP to the funded Startup 634. In some cases the Daemon Support pool 80 completes tasks that are used as input for tasks performed by a Daemon Team 20. When this situation occurs, certified IP is delivered to the Daemon Team and enters the flow between steps 622 and 623.

In some embodiments of the present invention, Daemons 10 may choose to transition to roles in the Startup they are funding 640. When a Daemon 10 leaves the Fund 30 to join a Startup 70, the Daemon Fund 30 is compensated accordingly. In this case, the Startup 70 executes a Daemon Buyout Offer 641 to the Daemon Fund 30. The Daemon Fund requests membership certification 642. An offer is certified by a membership vote 643. If the membership votes to accept the buyout offer, the Daemon Fund 30 informs the Startup 70 they accept the buyout offer 644. Just as all Daemons 10 share in the equity, all Daemons 10, even those not working on a Daemon Team 20 for the Startup 70 requesting the buyout, vote in a membership certification. Once the buyout offer is accepted 644, the Startup 70 provides the equity and/or cash buyout compensation 645 to the Daemon Fund 30. Finally, the Daemon transfers from the Daemon Fund to their role in the Startup 646.

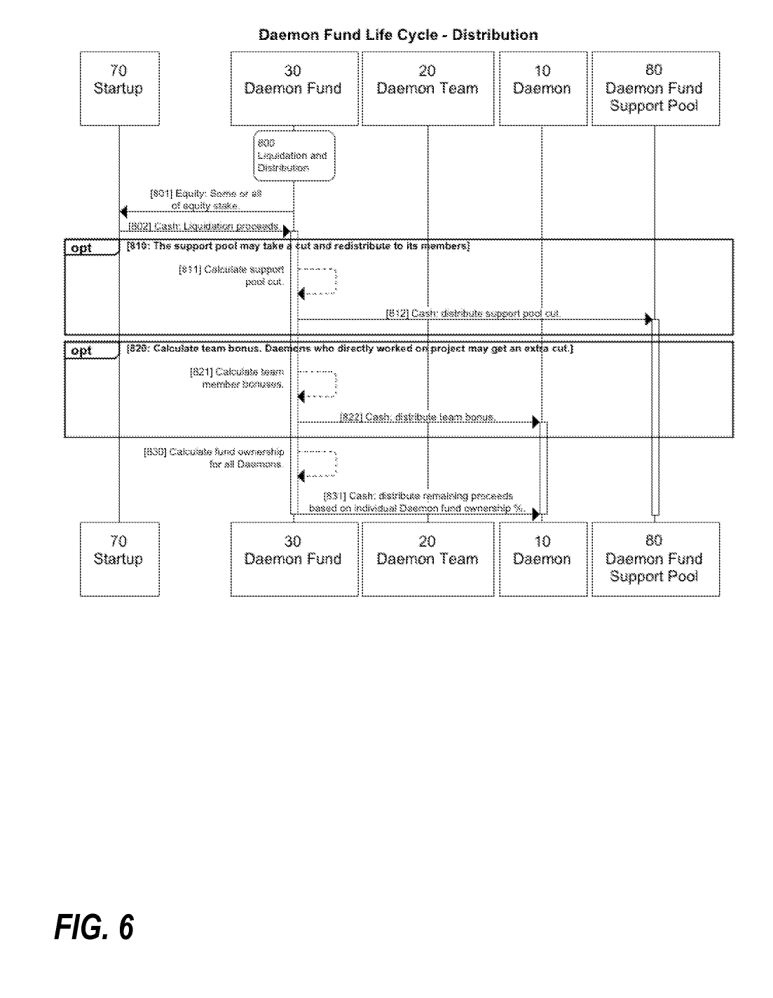

FIG. 6 is a flow chart showing the Distribution and Liquidation phase 800 of the Daemon Fund Life Cycle 1000 in detail. This phase is the final phase in the Daemon Fund Life Cycle 1000. At some point, the funded Startup 70 may have a “liquidity event” where the Daemon Fund 30 is given the opportunity to liquidate some or all of its ownership holdings in the Startup 70. Typical liquidity events are mergers or acquisitions of the Startup 70, or additional funding rounds where the Startup takes on additional investors and capital. This may happen during or after the Daemons 10 have completed some or all of their sweat equity investment tranches so the funds holdings are limited to ownership earned on completed funding tranches. When an event occurs, and the fund chooses or is required to liquidate some or all of its holdings, the Daemon Fund 30 returns its equity holdings 801 to the Startup 70 and receives cash or other valuable proceeds from the Startup 70 in return 802. The Daemon Support Pool 80 may be given an initial cut of the proceeds, which it distributes to its members 810. This is an optional step in the Life cycle and may occur in an embodiment, where a Daemon Team 20 receives specialized out-of-fund assistance from the Daemon Fund Support Pool 630, during the Investment Phase 600. The Daemon Fund 30 calculates the support pool cut 811, and then the proceeds are distributed to the Daemon Fund Support pool 812 which it then redistributes to its members in accordance with its own distribution models.

In one embodiment, bonuses may be calculated and distributed to Daemons 10 who worked directly on the project 820, either as permanent members of the lead Daemon Team 20, or temporarily as requested by the Team. The Daemon Fund 30 calculates Daemon “team” bonuses 821, and then the Daemon Fund 30 distributes the bonuses to the Daemons 822, based on their levels of investment in the Startup 70.

The final step in the Liquidation and Distribution Phase 800 occurs when the Daemon Fund calculates the fund ownership for all Daemons 830 after the optional distributions of 810 and 820. The Daemon Fund 30 then distributes the remaining proceeds based on individual Daemon fund ownership percentages 831.

As mentioned above, although the Distribution and Liquidation phase 800 ends the Daemon Fund Life Cycle 1000, it is understood that partial liquidations of a Startup 70 might happen several times before the fund's interest in a Startup 70 is finally liquidated, and that the Investment Phase 600 may be overlapped, with development continuing after one or more partial liquidations. Only after a complete liquidation would the cycle be finalized for that particular Startup 70.

### Daemon Artifact Details

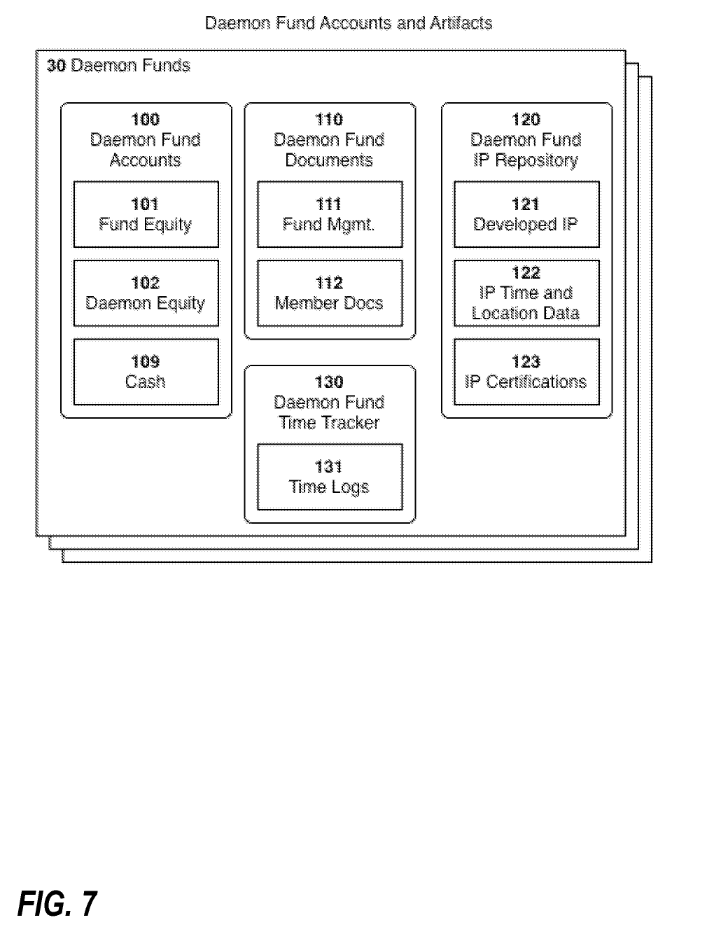

FIG. 7 is a block diagram detailing the Daemon Artifacts in FIG. 1. The Daemon Artifacts, which include but are not limited to, Daemon Fund Accounts 100, Daemon Fund Documents 110, Daemon Fund IP Repository 120, and a Daemon Fund Time Tracker System 130 were introduced in FIG. 1 and are described here in detail. The Daemon Fund Accounts 100, include a Fund Equity 101. The Fund Equity 101 is equity retained from funded startups 70. The equity may have future potential value such as stock options, warrants, convertible notes, etc, or present value such as stock. This Fund Equity account 101 holds the equity until it is liquidated during equity events with the proceeds distributed to the Daemons 10. In one embodiment, the Daemon Fund 30 may choose to hold the equity for a period of time after the Equity for drop is transferred 612. In another embodiment, the Daemon Fund 30 may choose to distribute the proceeds from equity liquidation to the Daemons 10 or the Daemon Fund Support pool 80 if they were involved in the IP delivered.

The Daemon Fund Accounts 100 also include Daemon Equity 102. Daemon Equity 102 is ownership of the fund itself, and represents sweat equity effort invested in funded startup projects. Each Daemon investment includes the units of effort (usually time, but could be any other agreed-upon metric), and any investment multipliers applied. In particular, the Daemon 10 may have skill and experience metrics that make their effort worth more or less than other Daemons 10 in the fund. Also, some types of effort to create IP are inherently more valuable than others so each task may have its own multiplier, based on the type of IP that was created. Each Daemon Equity account 102 also includes information about the Startup Investment made into the Daemon Fund 30. The startup specific investment balances are recorded in order to calculate daemon bonuses 821, if any are paid, which may be based on a percentage of the startup investment. Finally, in some embodiments, the Daemon Fund Accounts 100 may include a Cash Account 109. The Cash Account 109 may be used to hold cash during the Liquidation and Distribution phase 800 of the Daemon Fund Life Cycle 1000 if liquidation proceeds are received in cash form.

Referring back to FIG. 7, another Daemon Artifact is the Daemon Fund Documentation 110. This documentation may include but is not limited to Fund Management Documents 111. The Fund Management Documents 111 may include but are not limited to corporate formation and governance documents, a development rate chart, and a dynamic equity split model. As detailed earlier, investment multipliers may be added based on a skill. The development rate chart tracks the multipliers used for different types of development.

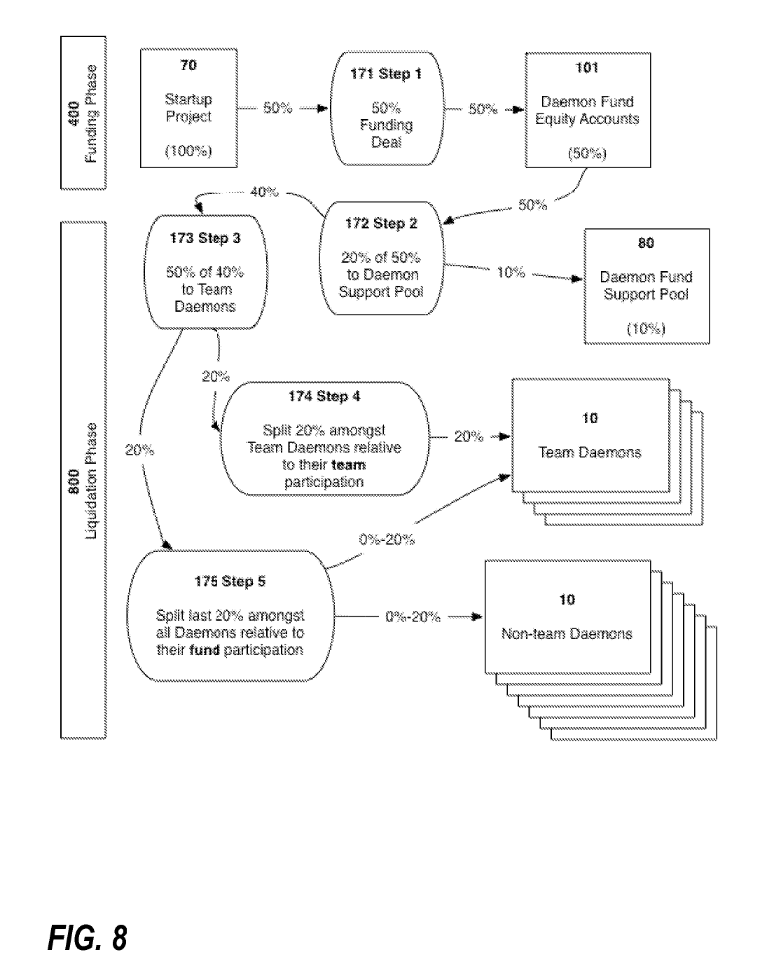

FIG. 8 is a flow chart showing an exemplary implementation of a Dynamic Equity Split model in one preferred embodiment of the Daemon Fund Management System 150. It illustrates how an ownership stake in a Startup 70 eventually becomes divided amongst the fund Daemons 10 and Support Pool 80 depending on their participation in fund sweat equity investment and support activities. It should be noted that Startup equity might not be distributed directly to Daemons 10 or the Support Pool 80, but rather that their ownership in the Startup can be traced through their ownership in the fund itself, and that distributions of proceeds from liquidated Startup equity will follow this model.

FIG. 8 shows an embodiment where the Daemon Fund 30 receives a 50% ownership stake in the Startup 70 during Step 1 171 during the Funding Phase 400 in return for promised sweat equity investment. It should be noted that this equity may also be earned and acquired over time in multiple tranches, during the Investment Phase 600, depending on the funding agreements. In either case, when liquidation of the equity stake occurs during the Liquidation and Distribution Phase 800, the Support Pool 80 receives a 20% cut in Step 2 172, which is equivalent to 10% of the funded startup. In Step 3 173 50% of the funds remaining stake, representing 20% of the startups value, is set aside for the Daemons 10 who worked directly on the Startup project, either as members of the Lead Team or as requested by the Lead Team. In Step 4 174, this cut is distributed to the project Daemons, in proportion to the amount of sweat equity they invested directly into the startup project. Finally, in Step 5 175, the rest of the fund's holdings, representing 20% of the startups value, are distributed to all fund Daemons in proportion to their sweat equity investments into the fund as a whole.

It should be understood that each Daemon Fund 30 may choose to set up a unique Dynamic Equity Split model depending on many factors such us but not limited to the Startup project, the role of the Daemon Support team 80, the duration of the project etc.

The Daemon Fund Documentation 110 also includes but is not limited to Daemon Membership Documents 112, such as membership or employment agreements, including but not limited to IP assignments, and non-competes. The membership documents may also include current dynamic equity split model parameters for Daemons based on skill, experience, etc. and the documents may include current and former 3rd-party IP agreements and non-compete agreements.

Referring back to FIG. 7, a third Daemon Artifact is the Intellectual Property Repository 120. This repository may contain but is not limited to, IP developed by the Daemons and the Support Daemons 121, time and location logs 122, and IP Certifications 123.

Developed IP 121 includes but is not limited to, source code, documentation, or any other work products that can be stored digitally. Time and location logs 122 are the stored copy of the output from the time tracker system 130 that is part of the certification of originality, as well as serving as the raw material for equity investment calculations. Finally, the IP Repository 120 stores IP certifications 123, which are digitally signed certifications that are done each time and in conjunction with developed IP 121 and the Time Tracker system 130 to certify that the IP was developed on the Daemon's own time and equipment and that the IP does not belongs to a third party. The developed IP 121, time and location logs 122, and IP Certifications 123 are digitally signed by the Daemon 10.

The final Daemon artifact is the Time tracker system 130. As Daemons 10 work on a project for a Startup 70, output from a logging application on a Daemon's development system, tracks their time and activities. The Time tracker log 131 gets checked into the IP repository 120 along with the results of the development session. As stated above, both of these items are digitally signed by the Daemon 10.

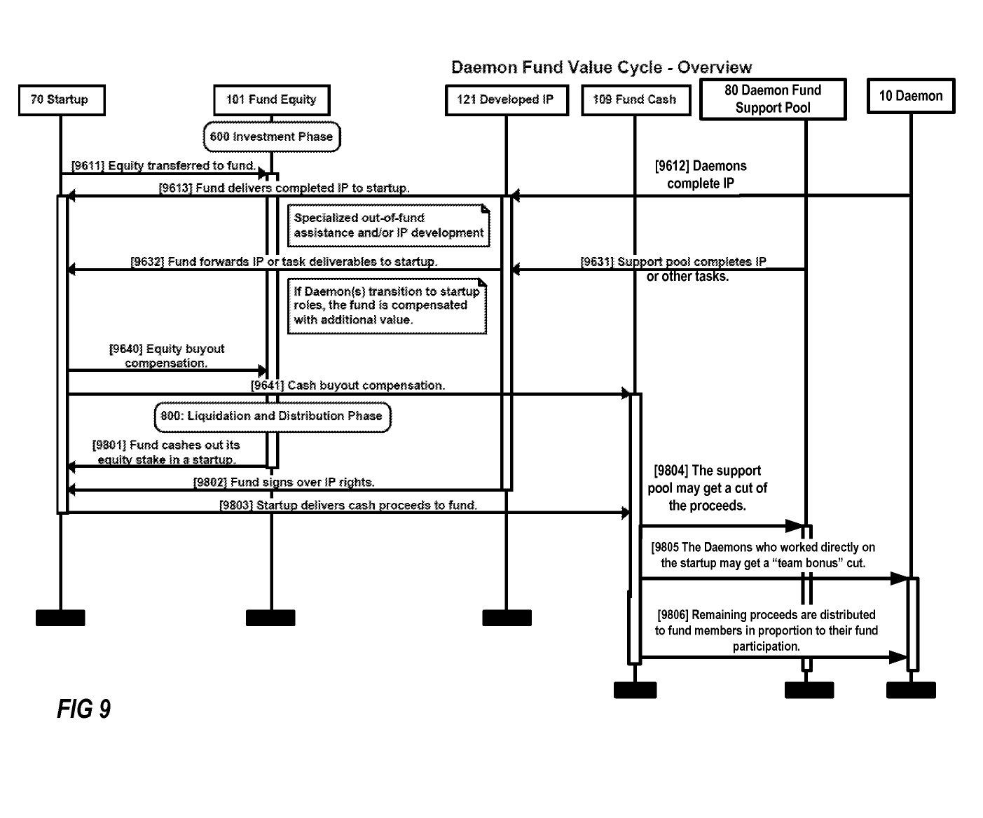

FIG. 9 is a flow chart showing an exemplary implementation of the Daemon Fund Value Cycle in one preferred embodiment of the Daemon Fund Management System 150. The Daemon Fund Value Cycle details the exchange of equity from the Startup 70 for developed IP 121 and/or actual Daemons 10 during the Investment phase 600 and the Liquidation and Distribution phase 800. It should be appreciated that FIG. 9 shows one of many possible flows for a Daemon Fund Value Cycle.

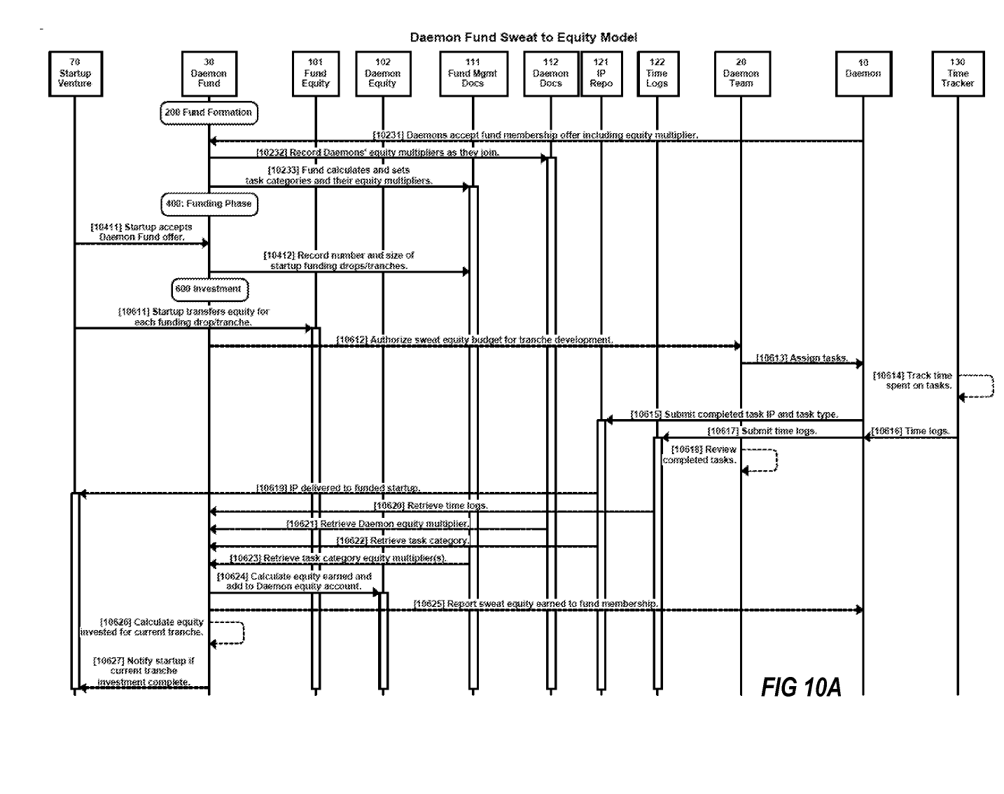

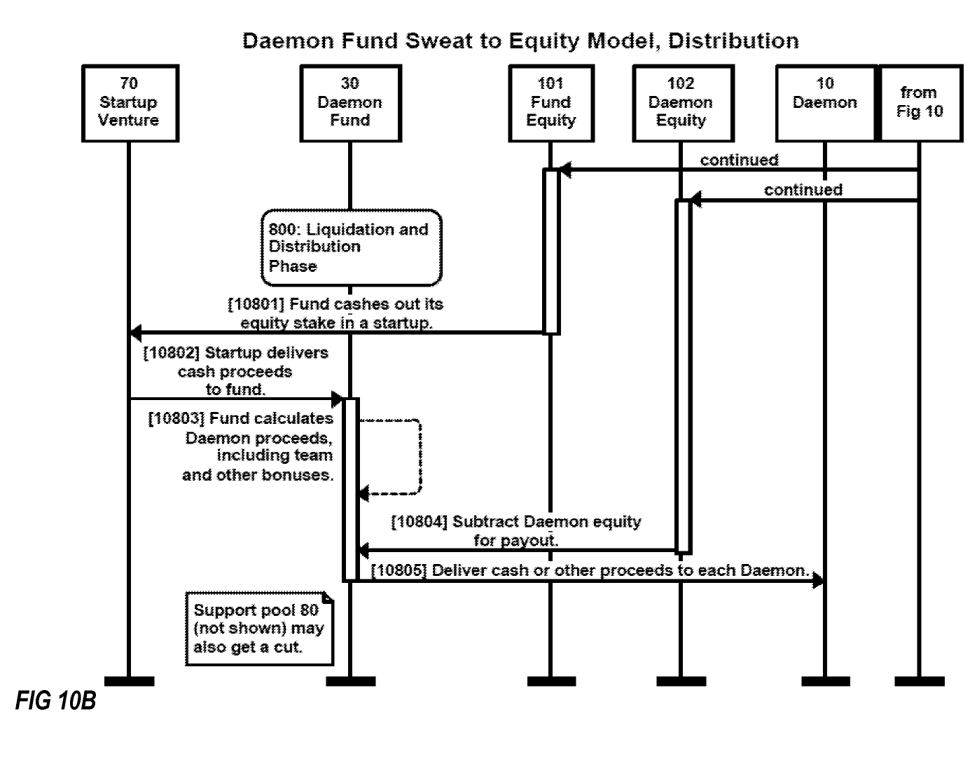

FIG. 10 is a flow chart showing an exemplary implementation of the Daemon Fund Sweat to Equity Model in one preferred embodiment of the Daemon Fund Management System 150. As described in FIG. 7, a Daemon's 10 time is tracked and may have a multiplier for the time value based on the particular skill of the Daemon. The Daemon Fund Sweat to Equity Model details the tracking of the Daemons chosen for a particular Daemon Team, how their time and developed IP 121 are tracked and their work or “Sweat” is converted to equity and eventually the Daemon's equity or payout from the Startup 70. The Daemon Fund Sweat to Equity Model includes all phases 200,400,600,800 of the Daemon Fund Life Cycle 1000. It should be appreciated that FIG. 10 shows one of many possible flows for a Daemon Fund Sweat to Equity Model.

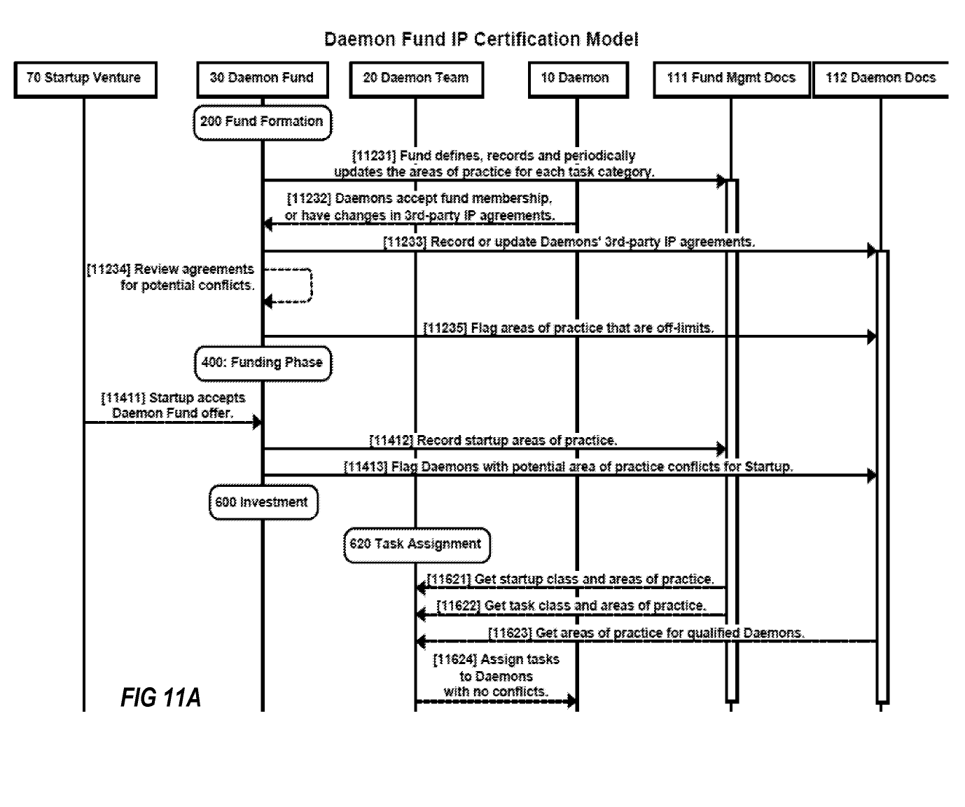

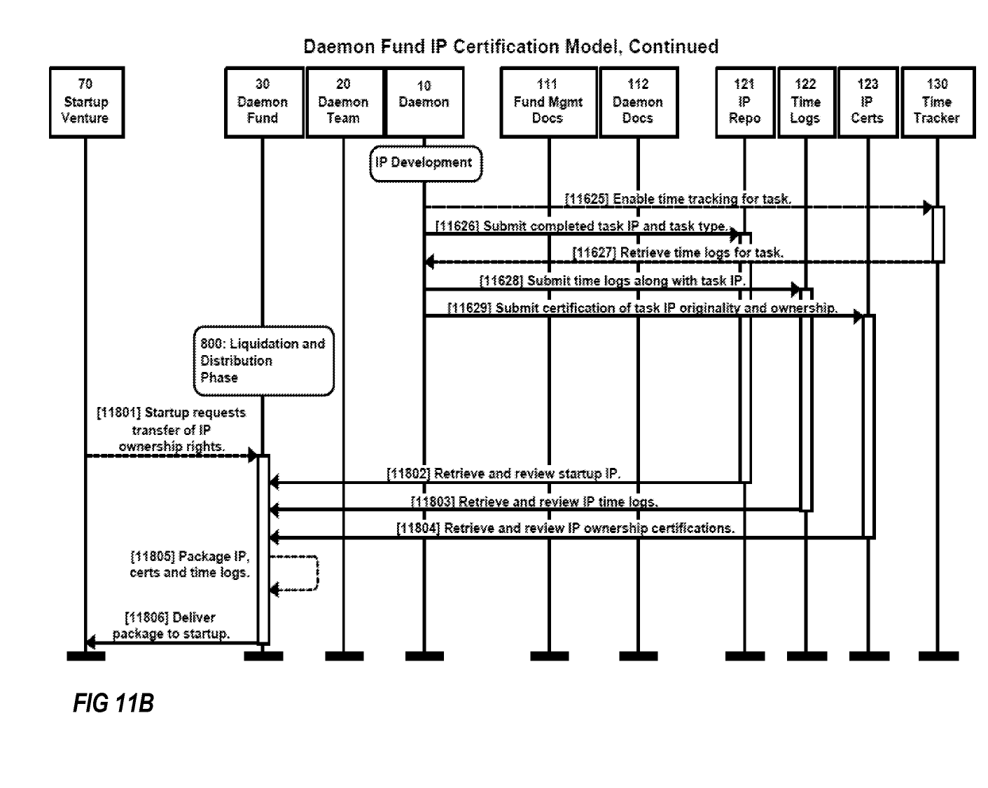

FIG. 11 is a flow chart showing an exemplary implementation of the Daemon Fund IP Certification model in one preferred embodiment of the Daemon Fund Management System 150. As described in FIG. 7, IP Certification 123, which are digitally signed certifications that are done each time and in conjunction with developed IP 121 and the Time Tracker system 122, are necessary to certify that the IP was developed on the Daemon's own time and equipment and that the IP does not belongs to a third party. FIG. 11 details one of many possible Daemon Fund IP Certification mode flows through all phases 200, 400, 600, 800 of the Daemon Fund Life Cycle 1000, including details on the use of the Time Tracker system 130 in the flow.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A computer-implemented method of organizing and managing a diversified sweat equity investment fund, comprising:
establishing a database, in at least one electronic data store, to track fund membership of a group of sweat equity investors, each investor defining a daemon;
tracking, in the at least one electronic data store, sweat equity invested into a fund by the daemons;
computing, via a computer device, and tracking, in the at least one electronic data store, the fund ownership of individual daemons based on the amount of their investments;
reinvesting the fund's pool of sweat equity into at least one external ventures in exchange for cash and/or ownership consideration in the at least one funded venture;
computing, via a computer device, and tracking, in the at least one electronic data store, the valuation of funded ventures;
computing, via a computer device, and tracking, in the at least one electronic data store, the fund ownership stakes in funded ventures;
tracking the proceeds of liquidation of ownership stakes in funded ventures; and
distributing venture liquidation proceeds to the daemons based on the respective fund ownership of each daemon.

2. The computer-implemented method of claim 1, wherein oversight of the fund is assigned to one or more fund managers who have final say in all fund actions, over and above general fund membership or committees.

3. The computer-implemented method of claim 1, wherein daemon membership in the fund is subject to review, and wherein the method further comprises:
organizing a membership committee of fund members and/or external advisors to recommend changes in membership status, including but not limited to acceptance into the fund, or expulsion from the fund; and
implementing a system whereby the fund accepts or rejects membership committee recommendations.

4. The computer-implemented method of claim 1, wherein the value of the sweat equity investments made by daemons into the fund are subject to an investment multiplier which sets the value of their fund investments relative to other fund members, and wherein the method further comprises:
upon fund admittance assigning a numerical multiplier to each daemon, based on their previous experience, skills, or other recognized values;
establishing a review process to periodically update investment multipliers; and
adjusting the fund investment value of sweat equity investments by each daemon's investment multiplier.

5. The computer-implemented method of claim 1, wherein investments of pooled fund sweat equity to funded ventures is subject to review by establishing a process by which funding proposals reviewed, valued, recommended, and then finally accepted or rejected by the fund.

6. The computer-implemented method of claim 1, wherein daemons are grouped into teams, and wherein the method further comprises:
assigning daemons to teams;
assigning teams to lead sweat equity investment for specific fund investment ventures; and
assigning and tracking the sweat equity investment budget for each team and funded venture.

7. The computer-implemented method of claim 6, wherein lead teams receive an additional bonus percentage of venture liquidation proceeds from their assigned ventures prior to the general fund distribution, and wherein the method further comprises:
tracking an agreed-upon team bonus percentage which is set when a team is assigned to the lead role for an investment venture;
calculating team bonus proceeds and subtracting them from and prior to the general fund distribution; and
distributing team bonus proceeds to lead team member daemons relative to the value of the sweat equity they invested in the venture that is being liquidated.

8. The computer-implemented method of claim 7, wherein daemons who are not part of a venture's lead team are able participate in the team bonus cut of venture liquidation proceeds, and wherein the method further comprises:
tracking and approving requests by teams for investment in team ventures by non-team daemons;
tracking daemon sweat equity investments for each funded venture; and
distributing team bonus proceeds to non-lead-team member daemons as if they were team members, relative to the value of the sweat equity they invested in the lead team's venture that is being liquidated.

9. The computer-implemented method of claim 1, wherein an advisory pool of external advisors is are made available to the fund, and wherein the method further comprises:
tracking and approving requests for external advisors to the advisory pool by fund entities; and
tracking the value of sweat equity investments made by advisors and reporting it back to the advisory pool.

10. The computer-implemented method of claim 9, wherein the advisory pool has an ownership stake in the Daemon Fund and participates in the distribution of venture liquidation proceeds.

11. The computer-implemented method of claim 9, wherein the advisors are treated in the same way as fund daemons for the purposes of participation in the distribution of venture liquidation proceeds.

12. The computer-implemented method of claim 1, wherein sweat equity tasks are classified and assigned multipliers, and wherein the method further comprises:
identifying classes of tasks and assigning multipliers based on their relative value to the fund;
tagging each investment of sweat equity with a classification; and
adjusting the relative valuation of each investment of sweat equity based on its classification.

13. The computer-implemented method of claim 1, wherein sweat equity invested by the daemons is automatically tracked and tagged, and wherein the method further comprises:
automatically recording the time durations of sweat equity activities performed by the daemons;
automatically collecting tagging information, during sweat equity activities, which supports and validates their investment value to the fund; and
verifiably associating or otherwise attaching the tagging information to sweat equity at the time it is submitted to the fund IP repositories.

14. The computer-implemented method of claim 13, wherein sweat equity investments, work products and verifiable tagging information are stored together in the fund IP repositories.

15. The computer-implemented method of claim 14, wherein the sweat equity tagging information is collected by a software time tracking product which installs on the daemon's computer and tracks their interaction with the system during development including their input, applications used, and names of the open windows they interact with.

16. The method of claim 13, wherein the fund IP repositories are electronic data stores such as a document management system or a software revision control system.

17. The computer-implemented method of claim 13, wherein the IP developed by the daemon and the associated tagging information are digitally signed as one element at the time they are added to the fund IP repositories using a digital key belonging to the daemon who created the IP.

18. The computer-implemented method of claim 1, wherein an audit trail is maintained that certifies that the daemons legally own the IP they create and invest into the fund, and wherein the method further comprises:
storing active IP-related agreements that daemons have with third parties;
categorizing potential areas of interference by task type and venture type;
when assigning tasks, limiting daemons from working on tasks that might cause potential IP interferences;
evaluating each daemon in the fund for potential interference when funding a new venture and sequestering those who might interfere from contributing IP;
requiring statements by the daemons with each of their sweat equity IP investments certifying that they have not violated their existing agreements;
storing certifications together with the associated IP or other sweat equity products in the fund IP repository;
digitally signing, as one element, the IP and its associated certifications using a digital key identifying the daemon who created and certified the IP; and
producing an IP certification report for funded ventures listing all of the IP developed by the fund for their project, the daemons who developed the IP, and their certifications of right to develop and deliver the IP.
